(19) United States
(12) Patent Application Publication
(10) Pub. No.: US 2019/0023886 A1
(43) Pub. Date: Jan. 24, 2019

(54) POLYMERIC COMPOSITION

(71) Applicant: Imerys Minerals Limited, Par Cornwall (GB)

(72) Inventors: Tarquin CROUCH, Southborough Kent (GB); Fatima REBIH, Toulouse (FR)

(21) Appl. No.: 16/070,079

(22) PCT Filed: Jan. 13, 2017
(86) PCT No.: PCT/GB2017/050081

§ 371 Date: Jul. 13, 2018

(30) Foreign Application Priority Data
Jan. 14, 2016 (GB) 1600741.1
Apr. 14, 2016 (GB) 1606557.5

(51) Int. Cl. C08L 23/12; C08K 3/34; D01F 6/28

(52) U.S. Cl. CPC C08L 23/12; C08K 3/346; D01F 6/28; C08L 2666/62; C08L 2205/08; C08L 2205/16; C08L 2666/30; C08L 2203/00

(57) ABSTRACT

Polymeric fibres, their use in, for example, cementitious construction materials, and methods of making the polymeric fibres and materials comprising same including, for example, cementitious construction materials.

### TECHNICAL FIELD

The present invention is directed to polymeric fibres, to their use in, for example, cementitious construction materials, and to methods of making the polymeric fibres and materials comprising same including, for example, cementitious construction materials.

### BACKGROUND OF THE INVENTION

It is known to use polymeric fibres to reinforce construction materials such as concrete. However, polymeric fibres may leach from reinforced concrete, and may become a source of pollution, particularly when used in inland and marine environments. Further, in mining operations, polymeric fibres may interfere with processing equipment such as pumps.

There is also an ever increasing demand to recycle and re-use polymer materials since this provides cost and environmental benefits. As the need to recycle polymer waste materials increase, there is a continuing need for the development of new ways to utilise recycled polymer materials.

Given the increasing demand for polymeric fibres for use in the reinforcement of cementitious construction materials, in view of some or all of the problems discussed, there is an ongoing need to develop new polymeric fibres suitable for, for example, reinforcement of cementitious construction materials, as well as other uses herein described.

### SUMMARY OF THE INVENTION

According to a first aspect, the present invention is directed to a polymeric fibre comprising a recycled polymer blend and a compatabilizer for the polymer blend, wherein the compatabilizer comprises an inorganic particulate and surface treatment agent on a surface of the inorganic particulate, and wherein the polymeric fibre is suitable for use:

(i) in a cementitious construction material; or

(ii) in a thermoset resin; or

(iii) in or as a geosynthetic material; or

(iv) in or as landscaping fabrics and the like; or

(v) in or as roofing underlay and the like; or

(vi) in or as automotive coverings, for example, floor carpets and the like; or

(vii) in or as backing material for floor coverings, for example, carpets; or

(viii) in furniture and the like; or

(ix) in or as an article requiring a dead fold and/or twist retention and/or memoryless capability.

According to a second aspect, the present invention is directed to a cementitious construction material comprising polymeric fibres according to the first aspect.

According to a third aspect, the present invention is directed to a thermoset resin comprising polymeric fibres according to the first aspect.

According to a fourth aspect, the present invention is directed to a geosynthetic material comprising or formed of polymeric fibres according to the first aspect.

According to a fifth aspect, the present invention is directed to a landscaping fabric comprising or formed of polymeric fibres according to the first aspect.

According to a sixth aspect, the present invention is directed to a roofing underlay comprising or formed of polymeric fibres according to the first aspect.

According to a seventh aspect, the present invention is directed to an automotive covering comprising or formed of polymeric fibres according to the first aspect.

According to an eighth aspect, the present invention is directed to a backing material for floor covering comprising or formed of polymeric fibres according to the first aspect.

According to a ninth aspect, the present invention is directed to furniture comprising or formed of polymeric fibres according to the first aspect.

According to an tenth aspect, the present invention is directed to an article requiring a dead fold and/or twist retention and/or memoryless capability comprising or formed of polymeric fibres according to the first aspect.

According to a eleventh aspect, the present invention is directed to a method of manufacturing a polymer fibre according to the first aspect, comprising extruding a polymer resin having a composition suitable to form a polymeric fibre according to the first aspect.

According to a twelfth aspect, the present invention is directed to the use of composition comprising a recycled polymer blend and a compatabilizer for the polymer blend in the manufacture of a polymeric fibre use in a cementitious construction material.

According to a thirteenth aspect, the present invention is directed to the use of a polymeric fibre according to the first aspect to reinforce a cementitious construction material.

According to a fourteenth aspect, the present invention is directed to use of a polymeric fibre according to the first aspect in a thermoset resin, for example, as a partial or total replacement for glass fibre.

According to a fifteenth aspect, the present invention is directed to the use of a polymeric fibre according to the first aspect in or as: a geosynthetic material, a landscaping fabric, a roofing underlay, an automotive covering, backing material for floor coverings, furniture, or an article requiring a dead fold and/or twist retention and/or memoryless capability.

### DETAILED DESCRIPTION OF THE INVENTION

Polymeric Fibre

The polymeric fibre may be used in a cementitious construction material, e.g., as a reinforcing additive. The polymeric fibre comprises a recycled polymer blend. In other embodiments, the polymeric fibre may be used in a thermoset resin, for example, as a partial or total replacement for glass fibre. In other embodiments, the polymeric fibre is for use in or as a geosynthetic material, or in or as landscaping fabrics and the like, or in or as roofing underlay and the like, or in or as automotive coverings, for example, floor carpets and the like, or in or as backing material for floor coverings, for example, carpets, or in furniture and the like, or in or as an article requiring a dead fold and/or twist retention and/or memoryless capability.

In certain embodiments, the recycled polymer blend is derived from polymer waste, for example, post-consumer polymer waste, post-industrial polymer waste, and/or post-agricultural waste polymer. In certain embodiments, the recycled polymer blend is or derived from recycled post-consumer polymer waste.

The polymer blend comprises different polymer types, for example, a mixture of polyethylene and polypropylene, or a mixture of at least two different types of polyethylene, or a mixture of different types of polyethylene and propylene, or a mixture of recycled polymer and virgin polymer

In certain embodiments, the recycled polymer blend comprises polypropylene (PP), for example, up to about 99 wt. % PP, based on the weight of the recycled polymer blend, for example, from about 10 wt. % to about 90 wt. %, or from about 20 wt. % to about 80 wt. %, or at least about 30 wt. %, or at least about 40 wt. %, or at least about 50 wt. %, or at least about 60 wt. %, or at least about 65 wt. %, or at least about 70 wt. %, or at least about 80 wt. %, or at least about 90 wt. %, or from about 90-95 wt. %, based on the weight of the recycled polymer blend. In such embodiments, the recycled polymer blend may additional comprise polyethylene (PE), for example, HDPE.

In certain embodiments, the recycled polymer blend comprises polyethylene, for example, HDPE, and polypropylene.

In certain embodiments, the recycled polymer blend constitutes 100% by weight of the polymer in the polymeric fibre.

In certain embodiments, the recycled polymer blend constitutes 100% by weight of the polymer in the polymer fibre, other than any polymer based impact modifier which may be present.

In certain embodiments, the recycled polymer blend comprises a mixture of different types of polyethylene, e.g., HDPE, LDPE, LLDPE, and/or MDPE.

In certain embodiments, at least 75% by weight of the polymer blend is a mixture of polyethylene and polypropylene, for example, a mixture of HDPE and polypropylene (based on the total weight of polymer in the polymer blend), for example, from 75% to about 99% of a mixture of polyethylene and polypropylene, for example, a mixture of HDPE and polypropylene. In such embodiments, HDPE may constitute from about 50% to about 95% by weight of the polymer blend (based on the total weight of the polymer of the filled polymer resin), for example, from about 60% to about 90% by weight, or from about 70% to about 90% by weight, of from about 70% to about 85% by weight, or from about 70% to about 80% by weight, or from about 75% to about 80% by weight of the polymer blend (based on the total weight of the polymer of the polymer blend). In such embodiments, PP may constitute up to about 99 wt. % of the recycled polymer blend, for example, from about 10 wt. % to about 90 wt. %, or from about 20 wt. % to about 80 wt. %, or at least about 30 wt. %, or at least about 40 wt. %, or at least about 50 wt. %, or at least about 60 wt. %, or at least about 65 wt. %, or at least about 70 wt. % of the recycled polymer blend.

In certain embodiments, at least 75% by weight of the recycled polymer blend is a mixture of polyethylene and polypropylene, for example, a mixture of HDPE and polypropylene (based on the total weight of polymer in the recycled polymer blend), for example, from 75% to about 99% of a mixture of polyethylene and polypropylene, for example, a mixture of HDPE and polypropylene. In certain embodiments, at least 90% by weight of the recycled polymer blend is a mixture of polyethylene and polypropylene, for example, a mixture of HDPE and polypropylene (based on the total weight of polymer in the recycled polymer blend), for example, from 90% to about 100% of a mixture of polyethylene and polypropylene, for example, a mixture of HDPE and polypropylene. In such embodiments, polyethylene, for example, HDPE, may constitute from about 50% to about 95% by weight of the recycled polymer blend, for example, from about 60% to about 90% by weight, or from about 70% to about 90% by weight, of from about 70% to about 85% by weight, or from about 70% to about 80% by weight, or from about 75% to about 80% by weight of the polymer blend (based on the total weight of the polymer of the recycled polymer blend). In such embodiments, PP may constitute up to about 99 wt. % of the recycled polymer blend, for example, from about 10 wt. % to about 90 wt. %, or from about 20 wt. % to about 80 wt. %, or at least about 30 wt. %, or at least about 40 wt. %, or at least about 50 wt. %, or at least about 60 wt. %, or at least about 65 wt. %, or at least about 70 wt. %, or at least about 80 wt. %, or at least about 90 wt. %, or from about 90-95 wt. of the recycled polymer blend (i.e., based on the total weight of polymer in the recycled polymer blend).

In certain embodiments, the HDPE is mixture of HDPE from different sources, for example, from different types of post-consumer polymer waste, e.g., recycled blow-moulded HDPE and/or recycled injection moulded HDPE.

Generally, HDPE is understood to be a polyethylene polymer mainly of linear, or unbranched, chains with relatively high crystallinity and melting point, and a density of about 0.96 g/cm³ or more. Generally, LDPE (low density polyethylene) is understood to be a highly branched polyethylene with relatively low crystallinity and melting point, and a density of from about 0.91 g/cm³ to about 0.94 g/cm. Generally, LLDPE (linear low density polyethylene) is understood to be a polyethylene with significant numbers of short branches, commonly made by copolymerization of ethylene with longer-chain olefins. LLDPE differs structurally from conventional LDPE because of the absence of long chain branching.

In certain embodiments, the polymer blend comprises up to about 20% by weight of polymers other than HDPE such as, for example, LDPE and LLDPE, any or all of which may be recycled from polymer waste, e.g., post-consumer polymer waste. In certain embodiments, the recycled polymer comprises up to about 20% by weight polypropylene, based on the total weight of the recycled polymer, for example, from about 1% to about 20% by weight, or from about 5% to about 18% by weight, or from about 10% to about 15% by weight, or from about 12 to about 14% by weight polypropylene.

In certain embodiments, the polymeric fibre comprises no more than about 50% by weight of virgin polymer (based on the total weight of polymer in the polymeric fibre), for example, no more than about 40% by weight of virgin polymer, or no more than about 30% by weight of virgin polymer, or no more than 20% by weight of virgin polymer, or no more than about 10% by weight of virgin polymer, or no more than about 5% by weight of virgin polymer, or no more than about 1% by weight of virgin polymer, or no more than about 0.1% by weight of virgin polymer.

In certain embodiments, the polymeric fibre is free of virgin polymer.

In certain embodiments, the recycled polymer blend constitutes at least about 40% by weight of the polymeric fibre, for example, at least about 50% by weight, or at least about 60% by weight, or at least about 70% by weight, for example, from about 40-90% weight, or from about 40-80% by weight, or from about 50-80% by weight, or from about 50-70% by weight, or from about 50-60% by weight, or from about 40-50% by weight of the polymeric fibre.

In certain embodiments, all of the polymer in the polymer fibre and, thus, all of the polymer in the polymer blend, is recycled polymer, e.g., derived from polymer waste such as, for example, post-consumer waste.

In certain embodiments, all of the polymer in the polymer fibre (other than any non-recycled polymer based impact modifier which may be present) and, thus, all of the polymer in the polymer blend, is recycled polymer, e.g., derived from polymer waste such as, for example, post-consumer waste.

Compatabilizer

In certain embodiments, the polymeric fibre comprises a compatabilizer for the polymer blend. The compatabilizer comprises an inorganic particulate and surface treatment agent on a surface of the inorganic particulate.

The compatabilizer may be present in the polymeric fibre in an amount ranging from about 1% up to about 70% by weight, based on the total weight of the polymeric fibre. For example, from about 2% to about 60% by weight, or from about 3% to about 50% by weight, or from about 4% to about 40% by weight, or from about 5% to about 30% by weight, or from about 5% to about 25% by weight, or from about 5% to about 20% by weight, or from about 5% to about 15% by weight, or from about 5% to about 10% by weight, based on the total weight of the polymeric fibre. The compatabilizer may be present in amount less than or equal to about 80% by weight of the polymeric fibre, for example, less than or equal to about 70% by weight, or less than or equal to about 60% by weight, or less than or equal to about 50% by weight, or less than or equal to about 40% by weight, or less than or equal to about 30% by weight, or less than or equal to about 20% by weight, or less than or equal to about 10% by weight, based on the total weight of the polymeric fibre.

The surface treatment agent (i.e., coupling modifier) may be present in the polymeric fibre in an amount of from about 0.01% by weight to about 4% by weight, based on the total weight of the polymeric fibre, for example, from about 0.02% by weight to about 3.5% by weight, or from about 0.05% by weight to about 1.4% by weight, or from about 0.1% by weight to about 0.7% by weight, or from about 0.15% by weight to about 0.7% by weight, or from about 0.3% by weight to about 0.7% by weight, or from about 0.5% by weight to about 0.7% by weight, or from about 0.02% by weight to about 0.5%, or from about 0.05% by weight to about 0.5% by weight, or from about 0.1% by weight to about 0.5% by weight, or from about 0.15% by weight to about 0.5% by weight, or from about 0.2% by weight to about 0.5% by weight, or from about 0.3% by weight to about 0.5% by weight, based on the total weight of the polymeric fibre.

In certain embodiments, the surface treatment agent comprises a first compound including a terminating propanoic group or ethylenic group with one or two adjacent carbonyl groups. The surface treatment agent may be coated on the surface of the inorganic particulate. A purpose of the surface treatment agent (e.g., coating) is to improve the compatibility of the inorganic particulate filler and the polymer matrix with which it is to be combined, and/or improve the compatibility of two or more different polymers in the recycled polymer composition by cross-linking or grafting the different polymers. In recycled polymer compositions comprising recycled and virgin polymer, the functional filler coating may serve to cross-link or graft the different polymers. Without wishing to be bound by theory, it is believed that coupling involves a physical (e.g., steric) and/or chemical (e.g., chemical bonding, such as covalent or van der Waals) interaction between the polymers and the surface treatment agent.

In one embodiment, the surface treatment agent (i.e., coupling modifier) has a formula (1):

A-(X—Y—CO)ₘ(O—B—CO)ₙOH (1)
wherein
   A is a moiety containing a terminating ethylenic bond with one or two adjacent carbonyl groups;
   X is O and m is 1 to 4 or X is N and m is 1;
   Y is Cl₁₋₁₈-alkylene or C₂₋₁₈-alkenylene;
   B is C₂₋₆-alkylene; n is 0 to 5;

provided that when A contains two carbonyl groups adjacent to the ethylenic group, X is N.

In an embodiment, A-X— is the residue of acrylic acid, optionally wherein (O—B—CO)ₙ is the residue of δ-valerolactone or c-caprolactone or a mixture thereof, and optionally wherein n is zero.

In another embodiment, A-X— is the residue of maleimide, optionally wherein (O—B—CO)ₙ is the residue of δ-valerolactone or c-caprolactone or a mixture thereof, and optionally wherein n is zero.

Specific examples of coupling modifiers are β-carboxy ethylacrylate, β-carboxyhexylmaleimide, 10-carboxydecylmaleimide and 5-carboxy pentyl maleimide. Exemplary coupling modifiers and there methods of preparation are described in U.S. Pat. No. 7,732,514, the entire contents of which is hereby incorporated by reference.

In another embodiment, the coupling modifier is β-acryloyloxypropanoic acid or an oligomeric acrylic acid of the formula (2):

CH₂═CH—COO[CH₂—CH₂—COO]ₙH (2)
wherein n represents a number from 1 to 6.

In an embodiment, n is 1, or 2, or 3, or 4, or 5, or 6.

The oligomeric acrylic acid of formula (2) may be prepared by heating acrylic acid in the presence of 0.001 to 1% by weight of a polymerization inhibitor, optionally under elevated pressure and in the presence of an inert solvent, to a temperature in the range from about 50° C. to 200° C. Exemplary coupling modifiers and their methods of preparation are described in U.S. Pat. No. 4,267,365, the entire contents of which is hereby incorporated by reference.

In another embodiment, the coupling modifier is β-acryloyloxypropanoic acid. This species and its method of manufacture is described in U.S. Pat. No. 3,888,912, the entire contents of which is hereby incorporated by reference.

The surface treatment agent is present in the functional filler in an amount effective to achieve the desired result. This will vary between coupling modifiers and may depend upon the precise composition of the inorganic particulate. For example, the coupling modifier may be present in an amount equal to or less than about 5 wt. % based on the total weight of the functional filler, for example equal to or less than about 2 wt. % or, for example equal to or less than about 1.5 wt. %. In an embodiment, the coupling modifier is present in the functional filler in an amount equal to or less than about 1.2 wt.% based on the total weight of the functional filler, for example equal to or less than about 1.1 wt. %, for example equal to or less than about 1.0 wt. %, for example, equal to or less than about 0.9 wt. %, for example equal to or less than about 0.8 wt. %, for example equal to or less than about 0.7 wt. %, for example, less than or equal to about 0.6 wt. %, for example equal to or less than about 0.5 wt. %, for example equal to or less than about 0.4 wt. %, for example equal to or less than about 0.3 wt. %, for example equal to or less than about 0.2 wt. % or, for example less than about 0.1 wt. %. Typically, the coupling modifier is present in the functional filler in an amount greater than about 0.05 wt. %. In further embodiments, the coupling modifier is present in the functional filler in an amount ranging from about 0.1 to 2 wt. % or, for example, from about 0.2 to about 1.8 wt. %, or from about 0.3 to about 1.6 wt. %, or from about 0.4 to about 1.4 wt. %, or from about 0.5 to about 1.3 wt. %, or from about 0.6 to about 1.2 wt. %, or from about 0.7 to about 1.2 wt. %, or from about 0.8 to about 1.2 wt. %, or from about 0.8 to about 1.1 wt. %.

In certain embodiments, a compound/compounds including a terminating propanoic group or ethylenic group with one or two adjacent carbonyl groups is/are the sole species present in the surface treatment agent.

In certain embodiments, a compound according to formula (1) or a mixture of compounds according to formula (1) is/are the sole species present in the surface treatment agent.

In certain embodiments, the first compound is not a fatty acid or a salt thereof.

In certain embodiments, the surface treatment agent additionally comprises a second compound selected from the group consisting of one or more fatty acids and one or more salts of fatty acids, and combinations thereof.

In one embodiment, the one or more fatty acids is selected from the group consisting of lauric acid, myristic acid, palmitic acid, stearic acid, arachidic acid, behenic acid, lignoceric acid, cerotic acid, myristoleic acid, palmitoleic acid, sapienic acid, oleic acid, elaidic acid, vaccenic acid, linoleic acid, linoelaidic acid, α-linolenic acid, arachidonic acid, eicosapentaenoic, erucic acid, docosahexaenoic acid and combinations thereof. In another embodiment, the one or more fatty acids is a saturated fatty acid or an unsaturated fatty acid. In another embodiment, the fatty acid is a C₁₂-C₂₄ fatty acid, for example, a C₁₆-C₂₂ fatty acid, which may be saturated or unsaturated. In one embodiment, the one or more fatty acids is stearic acid, optionally in combination with other fatty acids.

In another embodiment, the one or more salts of a fatty acid is a metal salt of the aforementioned fatty acids. The metal may be an alkali metal or an alkaline earth metal or zinc. In one embodiment, the second compound is calcium stearate.

The second compound, when present, is present in the functional filler in an amount effective to achieve the desired result. This will vary between coupling modifiers and may depend upon the precise composition of the inorganic particulate. For example, the second compound may be present in an amount equal to or less than about 5 wt. % based on the total weight of the functional filler, for example equal to or less than about 2 wt. % or, for example equal to or less than about 1 wt. %. In an embodiment, the, second compound is present in the functional filler in an amount equal to or less than about 0.9 wt.% based on the total weight of the functional filler, for example equal to or less than about 0.8 wt. %, for example equal to or less than about 0.7 wt. %, for example, less than or equal to about 0.6 wt. %, for example equal to or less than about 0.5 wt %, for example equal to or less than about 0.4 wt. %, for example equal to or less than about 0.3 wt. %, for example equal to or less than about 0.2 wt. % or, for example equal to or less than about 0.1 wt. %. Typically, the second compound, if present, is present in the functional filler in an amount greater than about 0.05 wt. %. The weight ratio of the coupling modifier to the second compound may be from about 5:1 to about 1:5, for example, from about 4:1 to about 1:4, for example, from about 3:1 to about 1:3, for example, from about 2:1 to about 1:2 or, for example, about 1:1. The amount of coating, comprising the first compound (i.e., the coupling modifier) and the second compound (i.e., the one more fatty acids or salts thereof), may be an amount which is calculated to provide a monolayer coverage on the surface of the inorganic particulate. In embodiments, the weight ratio of the first compound to the second compound is from about 4:1 to about 1:3, for example from about 4:1 to about 1:2, for example from about 4:1 to about 1:1, for example from about 4:1 to about 2:1, for example, from about 3.5:1 to about 1:1, for example from about 3.5:1 to 2:1 or, for example, from about 3.5:1 to about 2.5:1. In certain embodiments, the weight ratio of the first compound to the second compound ranges from infinite (i.e., the surface treatment agent is exclusively the first compound and no second compound is present) to about 1:1, for example, from infinite to about 2:1, or from infinite to about 4:1, or from infinite to about 6:1, or from infinite to about 8:1, or from infinite to about 10:1, or from infinite to about 20:1. In such embodiments, the first compound be a compound or mixture of compounds according to formula (1).

In certain embodiments, the surface treatment agent does not comprise a compound selected from the group consisting of one or more fatty acids and one or more salts of a fatty acid.

In certain embodiments, the surface treatment agent is or comprises an organic linker on a surface of the inorganic particulate. The organic linker has an oxygen-containing acid functionality. The organic linker is a basic form of an organic acid. By “basic form” is meant that the organic acid is at least partially deprotonated, e.g., by dehydrating an organic acid to form the corresponding oxyanion. In certain embodiments, the basic form of an organic acid is the conjugate base of the organic acid. The organic acid (and, thus, the organic linker) comprises at least one carbon-carbon double bond.

In certain embodiments, the organic linker is a non-polymeric species and, in certain embodiments, has a molecular mass of no greater than about 400 g/mol. By “non-polymeric” is meant a species which (i) is not formed by the polymerization of monomeric species, and/or (ii) has a relatively low molecular mass, e.g., a molecular mass of less than about 1000 g/mol, for example, a molecular mass of no greater than about 400 g/mol, and/or (iii) comprises no more than 70 carbon atoms in a carbon chain, for example, no more than about 25 carbon atoms in a carbon chain.

In certain embodiments, the non-polymeric species has a molecular mass of no greater than about 800 g/mol, or no greater than about 600 g/mol, or no greater than about 500 g/mol, or no greater than about 400 g/mol, or no greater than about 300 g/mol, or no greater than about 200 g/mol. Alternatively or additionally, in certain embodiments, the non-polymeric species comprises no more than about 50 carbon atoms, or no more than about 40 carbon atoms, or no more than about 30 carbon atoms, or no more than about 25 carbon atoms, or no more than about 20 carbon atoms, or no more than about 15 carbon atoms.

In certain embodiments, the compatibilizer comprises particulate and an organic linker on a surface of the particulate, the compatibilizer being obtained by at least partially dehydrating an organic acid having an oxygen-containing acid functionality and comprising at least one carbon-carbon double bond in the presence of the particulate. An exemplary organic acid is a carboxylic acid, and its basic form a carboxylate, e.g.,

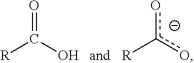

respectively, wherein R is an unsaturated C₂₊ group containing at least one carbon-carbon double bond. The carboxylate group (which is an oxyanion) is depicted in resonance form. The carboxylate group is an example of a conjugate base. In certain embodiments, R is an unsaturated C₃₊ group, or an unsaturated C₄₊ group, or an unsaturated C₅₊ group.

Without wishing to be bound by theory, it is believed that the basic form of the acid functionality coordinates/associates with the surface of the particulate, and the organic tail having at least one carbon-carbon double bond coordinates/associates with the different polymer species in the polymer blend. Thus, the compatibilizer serves to cross-link or graft the different polymer types, with the organic linker acting as coupling modifier, wherein the coupling involves a physical (e.g., steric) and/or chemical (e.g., chemical bonding, such as covalent or van der Waals) interaction between the different polymers and between the polymers and the particulate. The overall effect is to enhance the compatibility of the different polymer types in the polymer blend which, in turn, may enhance processing of the polymer blend and/or one or more physical properties (e.g., one or more mechanical properties) of an article of manufacture made from the polymer blend. The surface of the particulate may serve to balance the anionic charge of the organic linker. Further, the compatibilizing effect may enable greater quantities of particulate to be incorporated without adversely affecting the processability of the polymer blend and/or the physical properties of the articles made from the polymer blend. This, in turn, may reduce costs because less polymer (recycled or otherwise) is used.

In certain embodiments, the organic linker is the conjugate base of an organic acid, for example, a carboxylate or phosphate or phosphite or phosphinate or amino acid. In certain embodiments, the organic linker is a carboxylate. In alternate embodiments, the organic linker includes a maleimide ring (e.g., with an amide carboxylate functionality coordinates/associates with the surface of the particulate and an a carbon-carbon double bond coordinates/associates with the different polymer species in the polymer blend).

In certain embodiments, the organic linker comprises at least one carbon atom in addition to the carbon-carbon double bond. In certain embodiments, the organic linker comprises at least two carbon atoms, or at least three carbon atoms, or at least four carbon atoms, or at least five carbon atoms in addition to the carbon-carbon double bond. In certain embodiments, the organic linker comprises at least six carbon atoms, for example, a chain of at least six carbon atoms, including the at least one carbon-carbon double bond. In certain embodiments, the organic linker comprises only one carbon-carbon double bond. In certain embodiments, the organic linker comprises two carbon-carbon double bonds. In certain embodiments, the organic linker comprises three carbon-carbon double bonds. The moieties about the at least one carbon-carbon double bond may be arranged in a cis or trans configuration. The carbon-carbon double bond may be a terminal group or may be internal to the molecule, i.e., within the chain of carbon atoms.

In certain embodiments, the organic linker is:

CH₂═CH—(CH₂)ₐ—Z (1)

and/or

CH₃—(CH₂)_{b}—CH═CH—(CH₂)_{c}—Z (2)

wherein a is equal to or greater than 3;

wherein b is equal to or greater than 1, and c is equal to or greater than 0, provided that b+c is at least 2; and

wherein Z is a carboxylate group, a phosphate group, a phosphite or a phosphinate group.

In certain embodiments, a is from 6 to 20, for example, from 6 to 18, or 6 to 16, or 6 to 14, or 6 to 12, or 6 to 10, or 7 to 9. In certain embodiments, a is 8.

In certain embodiments, b and c are each independently from 4 to 10, for example, each independently from 5 to 11, or from 5 to 10, or from 6 to 9, or from 6 to 8. In certain embodiments, b and c are both 7.

In certain embodiments, when the organic linker is of formula (1), Z is a carboxylate group. In such embodiments, the compatibilizer may consist essentially of, or consist of, particulate (e.g., mineral particulate) and the organic linker of formula (1) and wherein Z is a carboxylate group.

In certain embodiments, when the organic linker is of formula (2), Z is a carboxylate group. In such embodiments, the compatibilizer may consist essentially of, or consist of, particulate (e.g., mineral particulate) and the organic linker of formula (2) and wherein Z is a carboxylate group.

In certain embodiments, the organic linker is a mixture of formula (1) and formula (2), optionally wherein Z is, in each case, a carboxylate group. In such embodiments, the compatibilizer may consist essentially of, or consist of, particulate (e.g., mineral particulate) the organic linker of formula (1) and wherein Z is a carboxylate group, and the organic linker of formula (2) and wherein Z is a carboxylate group.

In certain embodiments, the organic acid is an unsaturated fatty acid or derived from an unsaturated fatty acid. In certain embodiments, when the organic acid is an unsaturated fatty acid, the compatibilizer consists essentially of, or consists of, particulate (for example, mineral particulate) and organic linker. In such embodiments, the unsaturated fatty acid may be selected from one of myristoleic acid, palmitoleic acid, sapienic acid, oleic acid, elaidic acid, vaccenic acid, linoleic acid, linoelaidic acid, a-linolenic acid, arachidonic acid, eicosapentaenoic acid, erucuc acid and docosahexanoic acid. In such embodiments, the unsaturated fatty acid may be oleic acid, i.e., in certain embodiments, the compatibilizer comprises particulate (for example, mineral particulate) and the basic form of oleic acid. In certain embodiments, the compatibilizer consists of particulate (for example, mineral particulate) and the basic form of oleic acid.

In certain embodiments, the organic acid is derived from an unsaturated fatty acid. In certain embodiments, the organic acid is undecylenic acid, i.e., the organic linker is the basic form of undecylenic acid. In certain embodiments, the compatibilizer consists of particulate (for example, mineral particulate) and the basic form of undecylenic acid.

The Inorganic Particulate Material

The inorganic particulate material may, for example, be an alkaline earth metal carbonate or sulphate, such as calcium carbonate, magnesium carbonate, dolomite, gypsum, a hydrous kandite clay such as kaolin, halloysite or ball clay, an anhydrous (calcined) kandite clay such as metakaolin or fully calcined kaolin, talc, mica, perlite or diatomaceous earth, or magnesium hydroxide, or aluminium trihydrate, or wollastonite, or combinations thereof.

A preferred inorganic particulate material is calcium carbonate. Hereafter, the invention may tend to be discussed in terms of calcium carbonate, and in relation to aspects where the calcium carbonate is processed and/or treated. The invention should not be construed as being limited to such embodiments.

The particulate calcium carbonate used in the present invention may be obtained from a natural source by grinding. Ground calcium carbonate (GCC) is typically obtained by crushing and then grinding a mineral source such as chalk, marble or limestone, which may be followed by a particle size classification step, in order to obtain a product having the desired degree of fineness. Other techniques such as bleaching, flotation and magnetic separation may also be used to obtain a product having the desired degree of fineness and/or colour. The particulate solid material may be ground autogenously, i.e. by attrition between the particles of the solid material themselves, or, alternatively, in the presence of a particulate grinding medium comprising particles of a different material from the calcium carbonate to be ground. These processes may be carried out with or without the presence of a dispersant and biocides, which may be added at any stage of the process.

Precipitated calcium carbonate (PCC) may be used as the source of particulate calcium carbonate in the present invention, and may be produced by any of the known methods available in the art. TAPPI Monograph Series No 30, “Paper Coating Pigments”, pages 34-35 describes the three main commercial processes for preparing precipitated calcium carbonate which is suitable for use in preparing products for use in the paper industry, but may also be used in the practice of the present invention. In all three processes, a calcium carbonate feed material, such as limestone, is first calcined to produce quicklime, and the quicklime is then slaked in water to yield calcium hydroxide or milk of lime. In the first process, the milk of lime is directly carbonated with carbon dioxide gas. This process has the advantage that no by-product is formed, and it is relatively easy to control the properties and purity of the calcium carbonate product. In the second process the milk of lime is contacted with soda ash to produce, by double decomposition, a precipitate of calcium carbonate and a solution of sodium hydroxide. The sodium hydroxide may be substantially completely separated from the calcium carbonate if this process is used commercially. In the third main commercial process the milk of lime is first contacted with ammonium chloride to give a calcium chloride solution and ammonia gas. The calcium chloride solution is then contacted with soda ash to produce by double decomposition precipitated calcium carbonate and a solution of sodium chloride. The crystals can be produced in a variety of different shapes and sizes, depending on the specific reaction process that is used. The three main forms of PCC crystals are aragonite, rhombohedral and scalenohedral, all of which are suitable for use in the present invention, including mixtures thereof.

Wet grinding of calcium carbonate involves the formation of an aqueous suspension of the calcium carbonate which may then be ground, optionally in the presence of a suitable dispersing agent. Reference may be made to, for example, EP-A-614948 (the contents of which are incorporated by reference in their entirety) for more information regarding the wet grinding of calcium carbonate. The inorganic particulate, e.g., calcium carbonate, may also be prepared by any suitable dry grinding technique.

In some circumstances, additions of other minerals may be included, for example, one or more of kaolin, calcined kaolin, wollastonite, bauxite, talc, titanium dioxide or mica, could also be present.

When the inorganic particulate material is obtained from naturally occurring sources, it may be that some mineral impurities will contaminate the ground material. For example, naturally occurring calcium carbonate can be present in association with other minerals. Thus, in some embodiments, the inorganic particulate material includes an amount of impurities. In general, however, the inorganic particulate material used in the invention will contain less than about 5% by weight, preferably less than about 1% by weight, of other mineral impurities.

Unless otherwise stated, particle size properties referred to herein for the inorganic particulate materials are as measured by the well known conventional method employed in the art of laser light scattering, using a CILAS 1064 instrument (or by other methods which give essentially the same result). In the laser light scattering technique, the size of particles in powders, suspensions and emulsions may be measured using the diffraction of a laser beam, based on an application of Mie theory. Such a machine provides measurements and a plot of the cumulative percentage by volume of particles having a size, referred to in the art as the ‘equivalent spherical diameter’ (e.s.d), less than given e.s.d values. The mean particle size d₅₀ is the value determined in this way of the particle e.s.d at which there are 50% by volume of the particles which have an equivalent spherical diameter less than that d₅₀ value. The term d₉₀ is the particle size value less than which there are 90% by volume of the particles.

The d₅₀ of the inorganic particulate may be less than about 100 μm, for example, less than about 80 μm for example, less than about 60 μm for example, less than about 40 μm, for example, less than about 20 μm, for example, less than about 15 μm, for example, less than about 10 μm, for example, less than about 8 μm, for example, less than about 6 μm, for example, less than about 5 μm, for example, less than about 4, for example, less than about 3 μm, for example less than about 2 μm, for example, less than about 1.5 μm or, for example, less than about 1 μm. The d₅₀ of the inorganic particulate may be greater than about 0.5 μm, for example, greater than about 0.75 μm greater than about 1 μm, for example, greater than about 1.25 μm or, for example, greater than about 1.5 μm. The d₅₀ of the inorganic particulate may be in the range of from 0.5 to 20 μm, for example, from about 0.5 to 10 μm, for example, from about 1 to about 5 μm, for example, from about 1 to about 3 μm, for example, from about 1 to about 2 μm, for example, from about 0.5 to about 2 μm or, for example, from about 0.5 to 1.5 μm, for example, from about 0.5 to about 1.4 μm, for example, from about 0.5 to about 1.4 μm, for example, from about 0.5 to about 1.3 μm, for example, from about 0.5 to about 1.2 μm, for example, from about 0.5 to about 1.1 μm, for example, from about 0.5 to about 1.0 μm, for example, from about 0.6 to about 1.0 μm, for example, from about 0.7 to about 1.0 μm, for example about 0.6 to about 0.9 μm, for example, from about 0.7 to about 0.9 μm.

The d₉₀ (also referred to as the top cut) of the inorganic particulate may be less than about 150 μm, for example, less than about 125 μm for example, less than about 100 μm for example, less than about 75 μm, for example, less than about 50 μm, for example, less than about 25 μm, for example, less than about 20 μm, for example, less than about 15 μm, for example, less than about 10 μm, for example, less than about 8 μm, for example, less than about 6 μm, for example, less than about 4 μm, for example, less than about 3 μm or, for example, less than about 2 μm. Advantageously, the d₉₀ may be less than about 25 μm.

The amount of particles smaller than 0.1 μm is typically no more than about 5% by volume.

The inorganic particulate may have a particle steepness equal to or greater than about 10. Particle steepness (i.e., the steepness of the particle size distribution of the inorganic particulate) is determined by the following formula:

Steepness=100×(d₃₀/d₇₀),

wherein d₃₀ is the value of the particle e.s.d at which there are 30% by volume of the particles which have an e.s.d less than that d₃₀ value and d₇₀ is the value of the particle e.s.d. at which there are 70% by volume of the particles which have an e.s.d. less than that d70 value.

The inorganic particulate may have a particle steepness equal to or less than about 100. The inorganic particulate may have a particle steepness equal to or less than about 75, or equal to or less than about 50, or equal to or less than about 40, or equal to or less than about 30. The inorganic particulate may have a particle steepness from about 10 to about 50, or from about 10 to about 40.

The inorganic particulate is treated with a surface treatment agent, i.e., a coupling modifier, such that the inorganic particulate has a surface treatment on its surface. In certain embodiments, the inorganic particulate is coated with the surface treatment agent.

In certain embodiments, the inorganic particulate material of the compatabilizer is calcium carbonate, for example, GCC.

The polymer composition may additionally comprise a peroxide-containing additive. In an embodiment, the peroxide-containing additive comprises di-cumyl peroxide or 1,1-Di(tert-butylperoxy)-3,3,5-trimethylcyclohexane. The peroxide-containing additive may not necessarily be included with the surface treatment agent and instead may be added during the compounding of the functional filler and the polymer, as described below. In some polymer systems, e.g., those containing HDPE, the inclusion of a peroxide-containing additive may promote cross-linking of the polymer chains. In other polymer systems, e.g., polypropylene, the inclusion of a peroxide-containing additive may promote polymer chain scission. The peroxide-containing additive may be present in amount effective to achieve the desired result. This will vary between coupling modifiers and may depend upon the precise composition of the inorganic particulate and the polymer. For example, the peroxide-containing additive may be present in an amount equal to or less than about 1 wt. % based on the weight of the polymer in the polymer composition to which the peroxide-containing additive is to be added, for example, equal to or less than about 0.5 wt. %, for example, 0.1 wt. %, for example equal to or less than about 0.09 wt. %, or for example equal to or less than about 0.08 wt. % or for example, equal to or less than about 0.06 wt. %. Typically, the peroxide-containing additive, if present, is present in an amount greater than about 0.01 wt. % based on the weight of the polymer.

In certain embodiments, the polymeric fibre, or polymer resin from which it is formed, for example, by extrusion, does not comprise a peroxide-containing additive.

The compatabilizer may be prepared by combining the inorganic particulate, surface treatment agent and optional peroxide-containing additive and mixing using conventional methods, for example, using a Steele and Cowlishaw high intensity mixer, preferably at a temperature equal to or less than 80° C. The compound(s) of the surface treatment agent may be applied after grinding the inorganic particulate, but before the inorganic particulate is added to the optionally recycled polymer composition. For example, the surface treatment agent may be added to the inorganic particulate in a step in which the inorganic particulate is mechanically de-aggregated. The surface treatment agent may be applied during de-aggregation carried out in a milling machine.

The compatabilizer may additionally comprise an antioxidant. Suitable antioxidants include, but are not limited to, organic molecules consisting of hindered phenol and amine derivatives, organic molecules consisting of phosphates and lower molecular weight hindered phenols, and thioesters. Exemplary antioxidants include Irganox 1010 and Irganox 215, and blends of Irganox 1010 and Irganox 215.

In certain embodiments, the polymer fibre comprises filler in addition to the compatabilizer when present, i.e., one or more secondary filler components. The secondary filler component may not be treated with a surface treatment agent. In certain embodiments, the secondary filler component is not treated with a surface treatment agent. Such additional components, where present, are suitably selected from known filler components for polymer compositions. For example, the inorganic particulate used in the functional filler may be used in conjunction with one more other known secondary filler components, such as for example, wollastonite, carbon black and talc. In certain embodiments, the polymer composition comprises talc (in particulate form) as a secondary filler component. In certain embodiments, the weight ratio of inorganic particulate to secondary filler component is from about 1:1 to about 10:1, for example, from about 1:1 to about 5:1, or from about 2:1 to about 4:1. In certain embodiments, the inorganic particulate of the functional filler is calcium carbonate, for example, ground calcium carbonate, and the secondary filler component is uncoated talc. When a secondary filler component is used, it may be present in an amount of from about 0.1% to about 50% by weight of the polymer composition, for example, from about 1% to about 40% by weight, or from about 2% to about 30% by weight, or from about 2% to about 25% by weight, or from about 2% to about 20% by weight, or from about 3% to about 15% by weight, or from about 4% to about 10% by weight of the polymer composition.

In certain embodiments, the polymeric fibre comprises from 0 wt. % to 40 wt. % of talc and up to about 5 wt. %, for example, up to about 2 wt. %, or up to about 1 wt. % carbon black. The secondary filler component(s) may also serve to increase the density of the polymeric fibre.

In certain embodiments, the secondary filler is present in an amount of at least about 1% by weight, based on the total weight of the polymeric fibre.

A polymer fibre according to any preceding claim, further comprising an impact modifier, for example, a thermoplastic elastomer.

In certain embodiments, the polymeric fibre comprises an impact modifier, for example, up to about 20% by weight of an impact modifier, based on the total weight of the filled polymer resin, for example, from about 0.1% by weight to about 20% by weight, or from about 0.5% by weight to about 15% by weight, or from about 1% by weight to about 12.5% by weight, or from about 2% by weight to about 12.% % by weight, or from about 1% by weight to about 10% by weight, or from about 1% by weight to about 8% by weight, or from about 1% by weight to about 6% by weight, or from about 1% by weight to about 4% by weight of an impact modifier, based on the total weight of the polymer blend. The impact modifier may be included to improve or enhance the elongation at break of the polymeric fibre.

In certain embodiments, the impact modifier is an elastomer, for example, a polyolefin elastomer. In certain embodiments, the polyolefin elastomer is a copolymer of ethylene and another olefin (e.g., an alpha-olefin), for example, octane, and/or or butene and/or styrene. In certain embodiments, the impact modifier is a copolymer of ethylene and octene. In certain embodiments, the impact modifier is a copolymer of ethylene and butene.

In certain embodiments, the impact modifier is a recycled (e.g., post industrial) impact modifier.

In certain embodiments, the impact modifier, for example, polyolefin copolymer as described above, such as an ethylene-octene copolymer, has a density of from about 0.80 to about 0.95 g/cm³ and/or a MFI of from about 0.2 g/10 min (2.16 kg©190° C.) to about 30 g/10 min (2.16 kg©190° C.), for example, from about 0.5 g/10 min (2.16 kg©190° C.) to about 20 g/10 min (2.16 kg©190° C.), or from about 0.5 g/10 min (2.16 kg©190° C.) to about 15 g/10 min (2.16 kg©190° C.), or from about 0.5 g/10 min (2.16 kg©190° C.) to about 10 g/10 min (2.16 kg©190° C.), or from about 0.5 g/10 min (2.16 kg©190° C.) to about 7.5 g/10 min (2.16 kg©190° C.), or from about 0.5 g/10 min (2.16 kg©190° C.) to about 5 g/10 min (2.16 kg©190° C.), or from about 0.5 g/10 min (2.16 kg©190° C.) to about 4 g/10 min (2.16 kg©190° C.), or from about 0.5 g/10 min (2.16 kg©190° C.) to about 3 g/10 min (2.16 kg©190° C.), or from about 0.5 g/10 min (2.16 kg©190° C.) to about 2.5 g/10 min (2.16 kg©190° C.), or from about 0.5 g/10 min (2.16 kg©190° C.) to about 2 g/10 min (2.16 kg©190° C.), or from about 0.5 g/10 min (2.16 kg©190° C.) to about 1.5 g/10 min (2.16 kg©190° C.). In such or certain embodiments, the impact modifier is an ethylene-octene copolymer having a density of from about 0.85 to about 0.86 g/cm³. Exemplary impact modifiers are polyolefin elastomers made by DOW under the Engage® brand, for example, Engage® 8842. In such embodiments, the compounded polymer blend may additionally comprise an antioxidant, as described herein.

In certain embodiments, the impact modifier is a copolymer based on styrene and butadiene, for example, a linear block copolymer based on styrene and butadiene. In such embodiments, the impact modifier may have a MFI of from about from about 1 to about 5 g/10 min (200° C. @ 5.0 kg), for example, from about 2 g/10 min (200° C. @ 5.0 kg) to about 4 g/10 min (200° C. @ 5.0 kg), or from about 3 g/10 min (200° C. @ 5.0 kg) to about 4 g/10 min (200° C. @ 5.0 kg). In such embodiments, the linear block copolymer may be a recycled linear block copolymer.

In certain embodiments, the impact modifier is a copolymer based on styrene and isoprene, for example, a linear block copolymer based on styrene and isoprene. In such embodiments, the impact modifier may have a MFI of from about from about 5 to about 20 g/10 min (230° C. @ 2.16), for example, from about 8 g/10 min (230° C. @ 2.16 kg) to about 15 g/10 min (230° C. @ 2.16 kg), or from about 10 g/10 min (230° C. @ 2.16 kg) to about 15 g/10 min (230° C. @ 2.16 kg). In such embodiments, the linear block copolymer may be recycled.

In certain embodiments, the impact modifier is a triblock copolymer based on styrene and ethylene/butene. In such embodiments, the impact modifier may have a MFI of from about 15 g/10 min (200° C. @ 5.0 kg) to about 25 g/10 min (200° C. @ 5.0 kg), for example, from about 20 g/10 min (200° C. @ 5.0 kg) to about 25 g/10 min (200° C. @ 5.0 kg).

MFI may be determined in accordance with ISO 1133.

In certain embodiments, there is crosslinking between the impact modifier and one or more polymers of the polymer blend, for example, in embodiments in which the impact modifier is a linear block copolymer based on styrene and butadiene, or on styrene and isoprene, and/or the polymer blend comprises PE. In some embodiments, the impact modifier may be miscible in the polymer blend.

In certain embodiments, the impact modifier is an optionally recycled styrene-butadiene-styrene block copolymer.

The polymeric fibre may be formed by extrusion. For example, the polymeric fibre may formed by extruding a polymer resin having an MFI of at least about 0.5 g/10 mins (2.16 kg @ 190° C.), for example, at least about, or at least about 0.75 g/10 mins (2.16 kg @ 190° C.), 1.0 g/10 mins (2.16 kg @ 190° C.). The polymer resin comprises the recycled polymer blend, and any additional components, e.g., additional polymer other than the recycled polymer blend, compatabilizer, secondary filler components and impact modifier.

In certain embodiments, the polymer resin and/or the polymeric fibre comprises:
a mixed recycled polymer blend having a PP content of equal to or greater than about 70% by weight, based on the weight of the mixed recycled polymer blend or the total weight of the polymeric fibre,
from about 5% to about 25% by weight of a compatabilizer,
from about 0% to about 40% by weight of talc as a secondary filler,
from about 0% to about 10% by weight of a recycled styrene-butadiene-styrene block copolymer impact modifier, and
up to about 1% by weight carbon black

In certain embodiments, the polymer resin and/or the polymeric fibre has an MFI of from about 1.0 to about 20.0 g/mins @ 190° C./2.16 kg, for example, an MFI of from about 1.0 to about 15 g/10 mins @ 190° C./2.16 kg, for example, from about 1.0 to about 10 g/10 mins @ 190° C./2.16 kg, or from about 1.0 to about 8 g/10 min @ 190° C./2.16 kg, or from about 1.0 to about 6 g/10 min @ 190° C./2.16 kg, or from about 1.0 to about 5 g/10 min @ 190° C./2.16 kg, or from about 1.0 to about 4.0 g/10 min @ 190° C./2.16 kg, or from about 1.0 to about 3.0 g/10 min @ 190° C./2.16 kg.

In certain embodiments, the polymeric fibre has a density such that the fibre sinks in a body of water, for example, a body of salt water, or a body of fresh water, or a marine body of water, or a reservoir, for example, a man-made reservoir, or lake, or pond, or pool.

In certain embodiments, the polymeric fibre has a density of greater than 1.0 g/cm³. In this and other embodiments, the polymeric fibre may be a polyolefinic fibre, i.e., a polymeric fibre in which the polymer blend is comprised exclusively of polyolefinic polymer(s).

In certain embodiments, the polymeric fibre has a density of equal to or greater than about 1.01 g/cm³, or equal to or greater than about 1.05 g/cm³, or equal to or greater than about 1.10 g/cm³, or equal to or greater than about 1.20 g/cm³, or equal to greater than about 1.30 g/cm³, or equal to or greater than about 1.40 g/cm³, or equal to or greater than about 1.50 g/cm³, or equal to or greater than about 1.60 g/cm³, or equal to or greater than about 1.70 g/cm³. In certain embodiments, the polymeric fibre has a density of no greater than about 10.0 g/cm³, for example, no greater than about 5.0 g/cm³, or no greater than about 2.0 g/cm³. Density may be determined in accordance with IS01183. As described below, in certain embodiments a densifier additive may be included to increase the density of the polymeric fibre.

Advantageously, therefore, in certain embodiments, there are provided polymer fibres which not only increase the utility of mixed-waste polymers, but also reduce or ameliorate the problem of fibre leaching and the concomitant environmental problems owing to the utilization of higher density polymeric fibres which will sink in marine environments and settle on the marine bed, reducing the chances of the fibre being eaten by marine fish and animals and the like.

In certain embodiments, the polymeric fibre has a substantially regular cross-section. In certain embodiment, the polymeric fibre has a substantially circular cross-section, optionally of diameter in the range of from about 0.1 to 10 mm, for example, from about 0.2 to about 7.5 mm, or from about 0.3 mm to about 5.0 mm, or from about 0. 5 mm to about 4.0 mm, or from about 0.75 mm to about 3.0 mm, or from about 1.0 mm to about 3.0 mm. Additionally or alternatively, the polymeric fibre may have a length of up to about 1000 mm, for example, up to about 750 mm, or up to about 500 mm, or up to about 250 mm, or up to about 200 mm, or up to about 150 mm, or up to about 100 mm, or up to about 75 mm, or up to about 50 mm, or up to about 25 mm, or up to about 15 mm, or up to about 5 mm. In certain embodiments, the polymeric fibre has a length of from about 25 mm to about 75 mm.

In certain embodiments, the polymeric fibre comprises at least about 50% by weight polypropylene, based on the total weight of the polymeric fibre, for example, at least about 60% by weight polypropylene, or at least about 70% by weight polypropylene.

In certain embodiments, the polymeric fibre has one or more of the following properties:

a. a tensile strength of at least 200 MPa, for example, at least about 300 MPa, or at least about 400 MPa; and/or

b. resistant to alkali; and/or

c. hydrophilic or rendered hydrophilic by inclusion of a suitable additives or application of suitable surface coating; and/or

d. a melting point of at least about 100° C., of example, at least about 120° C., or at least about 140° C., or at least about 150° C., or at least about 160° C., or at least about 170° C., or at least about 180° C., or at least about 190° C., or at least about 120° C.

Tensile strength may be determined in accordance with any suitable method for measuring the tensile strength of a polymeric fibre.

In certain embodiments, the polymer fibre has a tensile strength of at least about 400 MPa and a melting point of at least about 160° C.

In certain embodiments, the polymeric fibre can be rendered hydrophilic by treatment with a surface coating agent. For example, the polymeric fibre can be surface coated with a hydrophilizing reagent such as Moisturf™ (available from Oerlikon Barmag, Remscheid, Germany). For the avoidance of doubt, the surface coating agent is a separate component which may be included in addition to the surface treatment agent described herein. The surface treatment agent may be present in any suitable amount in order to render the polymer fibre hydrophilic.

In certain embodiments, use hydrophilic surface treated fibers can serve to further reduce or ameliorate the problem of fibre leaching and the concomitant environmental problems by allowing more complete wetting of fibers entering the marine environment, and the resulting reduction of adherent bubbles which could otherwise serve to increase the buoyancy of the fibers. Thus hydrophilic coating can help to ensure that the higher density polymeric fibres which will sink in marine environments and settle on the marine bed, reducing the chances of the fibre being eaten by marine fish and animals and the like. In certain other embodiments, the hydrophilizing surface treatment can serve to decrease the surface tension interactions between the fibre and the water, thereby facilitating improved sinking of the fibre.

In certain embodiments, the hydrophilizing treatment can also be used to decrease incidence of adherent bubbles in other polymer fiber systems and/or to decrease the surface tension interactions between the fibers and water. For example, in one embodiment the hydrophilizing treatment can be used to prepare hydrophilic polymer fibers, with or without inclusion of a second polymeric material. In another embodiment, the hydrophilizing treatment can be used to prepare hydrophilic polyamide fibers, with or without inclusion of a second polymeric material or recycled polymer material.

In certain embodiments, and in addition the mandatory surface treatment agent and optional secondary filler component, the polymer fibre may comprising a densifier additive. A densifier additive is an additive which serves to increase the density of the polymeric fibre (i.e., relative to the polymer fibre absent the densifier). The densifier additive may be used in any suitable amount which serves to increase the density of the polymer fibre, for example, in amount such that the polymer fibre has a density sufficient to cause it to sink in salt, fresh or estuarial bodies of water. In certain embodiments, the densifier additive is added in suitable amount to increase the density of the polymer fibre to equal to or greater than about 1.10 g/cm³, or equal to or greater than about 1.20 g/cm³, or equal to greater than about 1.30 g/cm³, or equal to greater than about 1.40 g/cm³, or equal to or greater than about 1.50 g/cm³, or equal to or greater than about 1.60 g/cm³, or equal to or greater than about 1.70 g/cm³.

In certain embodiments, the polymeric fibre comprises up to about 50 wt. % of the densifier additive, based on the total weight of the polymer fibre, for example, from about 1 wt. % to about 50 wt. %, or at least about 5 wt. %, or at least about 10 wt. %, or at least about 15 wt. %, or at least about 20 wt. %, or at least about 25 wt. %, or at least about 30 wt. %, or at least about 35 wt. %, or at least about 40 wt. %, or at least about 45 wt. %. In certain embodiments, the polymer fibre comprises from about 20-50 wt. % of the densifier additive, based on the total weight of the densifier additive, for example, from about 30-50 wt. %, or from about 35-50 wt. %, or from about 30-40 wt. %, or from about 35-45 wt. %, or from about 40-50 wt. %.

In certain embodiments, the densifier additive has a specific gravity of at least about 4000 kg/m³, for example, from about 4000-5000 kg/m³, or from about 4000-4750 kg/m³, or from about 4000-4500 kg/m³, or from about 4150-4450 kg/m³. In certain embodiments, the densifier additive has a density of at least about 4.0 g/cm³, for example, from about 4.0-6.0 g/cm³, or from about 4.0-5.0 g/cm³, or from about 4.2-4.8 g/cm³, or from about 4.3-4.6 g/cm³. In certain embodiments, the densifier is in particulate form having a d₅₀ of less than about 5.0 μm, for example, from about 0.1 μm to about 4.0 μm, or from about 0.5 μm to about 2.0 μm, or from about 1.0 to about 1.5 μm. Additionally, the densifier additive may have a dio of from about 0.25 μm to about 0.75 μm and/or a d₉₀ of from about 3.0 μm to about 4.0 μm. In certain embodiments, the densifier additive is selected from barium sulphate (also known as barite), hematite, ilmenite, hausmannite and mixtures thereof. In certain embodiments, the densifier additive is barium sulphate, optionally having a d₅₀ of from about 0.5 μm to about 2.0 μm, or from about 1.0 to about 1.5 μm, and optionally present in an amount of from about 30 wt. % to about 50 wt. %. In such embodiments, the barium sulphate may be precipitated barium sulphate.

In certain embodiments, the polymeric fibre is suitable for use in a fibre-reinforced concrete meeting standards BS EN14489 and/or ASTM C 116-03.

In certain embodiments, the polymeric fibre is orientated, for example, during the extrusion process in order to modify, for example, improve or enhance a desirable mechanical property such, as for example, tenacity.

The polymer fibre may be in the form of a filament, for example, a monofilament or a multifilament (e.g., comprising a bundle of polymeric fibres). The polymeric fibre may be fibrillated.

Cementitous Construction Material

In certain embodiments, the polymeric fibre is incorporated in a construction material, for example, a cementitious construction material. The polymeric fibre serves to reinforce the cementitious construction material. In certain embodiments, the cementitious construction material is a concrete or a mortar. In certain embodiments, the concrete comprises cement (e.g., Portland cement and/or fly ash), aggregate materials, and optional chemical additives. The aggregate may comprise one or more of a relatively fine aggregate (e.g., sand) and a relatively coarse aggregate (e.g., gravel or crushed stone).

The cementitious material may comprise at least about 0.1 wt. % of polymeric fibre, based on the weight of the cement, for example, from about 0.01 wt. % to about 50 wt. %, for example, from about 0.05 wt. % to about 40 wt. % polymeric fibre, or from about 0.1 w. % to about 30 wt. % of polymer fibre, or from about 0.1 wt. % to about 20 wt. % of polymeric fibre, or from about 0.1 wt. % to about 15 wt. % of polymeric fibre, or from about 0.1 wt. % to about 10 wt. % of polymeric fibre, or from about 0. 1 wt. % to about 5 wt. % of polymer fibre, or from about 0.1 wt. % to about 4 wt. % of polymeric fibre, or from about 0.1 wt. % to about 4 wt. % of polymeric fibre, or from about 0.1 wt. % to about 3 wt. % of polymeric fibre, or from about 0.1 wt. % to about 2 wt. % of polymeric fibre, or from about 0.1 wt. % to about 1. 5 wt. % of polymeric fibre, or from about 0.1 wt. % to about 1 wt. % of polymeric fibre, or from about 0.1 wt. % to about 0.75 wt. % of polymeric fibre, or from about 0.1 wt. % to about 0.5 wt. % of polymeric fibre. In certain embodiments, the cementitious construction material comprises at least about 0.2 wt. % of polymeric fibre, or at least about 0.4 wt. % of polymeric fibre, or at least about 0.6 wt. % of polymeric fibre or at least about 0.8 wt. % of polymeric fibre, or at least about 1 wt. % of polymeric fibre, based on the weight of cement.

The polymeric fibre may be incorporated in the cementitious construction material during manufacture of the cementitious construction material, e.g., as the various components of the construction material are combined, e.g., in a concrete mixer. The polymeric fibre may be incorporated in the cementitious construction material following its manufacture but before use in the manufacture of a structure or structural components. The polymeric fibre may be dispersed in the cementitious construction using one or more dispersing agents, e.g., carboxy methyl cellulose, silica fume and/or blast furnace slag. The polymeric fibre may be incorporated into the cementitious construction material under conditions of high shear, for example, using a high shear mixer. The polymer fibre may be added in doses or batches, which may prevent entanglement or clumping of the polymeric fibre. Following incorporation, the polymeric fibre is advantageously dispersed substantially homogenously throughout the cementitious construction material.

Without wishing to be bound by theory, it is believed that the presence of inorganic particulate in the polymeric fibres serves to roughen, at least in part, the surfaces of the polymeric fibre (i.e., all other things being equal, the surfaces of the polymeric fibre are rougher than a polymeric fibre absent the inorganic particulate), particularly as the polymeric components are “stretched” around the filler during the orientation by machine direction extension. Reinforcing fibres generally work to prevent or ameliorate crack propagation by how well they are bonded to the concrete. The roughened surfaces of the polymeric fibres according to certain embodiments improve that bonding, and the polymeric fibres are more likely to be retained across crack interfaces and prevent or ameliorate crack extension (e.g., in cementitious materials).

The cementitious construction material incorporating the polymer fibre may be of a composition and form which is suitable for applications such as tunnelling, mining, residential, pre-casts, marine (e.g., jetties, piers, and subsea structures such as well-bores and well-heads) and civil infrastructure (e.g., bridges, roads, buildings, etc.).

In certain embodiments, the cementitious constructions material incorporating the polymeric fibre meets standards BS EN14489 and/or ASTM C 116-03.

The cementitious construction may include other reinforcing materials such as, for example, steel reinforcements (e.g., wires and/or rods) and/or polymeric fibres other than those described herein, carbon fibre, aramid fibre, basalt fibre, glass fibre.

Structural and structural components formed from the cementitious construction material incorporating the polymer fibres are many and various and include, for example, tunnels, e.g., linings, and parts thereof, pre-casts, marine structures (e.g., e.g., jetties, piers, and subsea structures such as well-bores and well-heads), structures for mines, including linings, and civil infrastructures, such as bridges, roads, buildings, dams, walls, and the like, and parts or sections thereof.

Thermoset Resins

In certain embodiments, the polymeric fibre is incorporated in thermoset resins (and articles formed therefrom), for example, as a partial or total replacement for glass fibres which are traditionally used in thermoset resins for reinforcement. Use of the polymer fibres instead of glass fibres offers improvements in the recyclability of the thermoset resin, and should reduce the weight of the resin and any article formed therefrom.

Thermoset resins are many and various and will typically include other chemicals to improve their processability such, as for example, a resin system (including curing agents, hardeners, inhibitors and/or plasticisers, and the like) and fillers, such as those described herein.

Thermoset resins include polyester, epoxy, phenolics, vinyl ester, polyurethane, silicone, polyamide and polyamide-imide.

The polymer fibres may be incorporated during manufacture of the thermoset resin via conventional methods available in the art.

In certain embodiments, a thermoset resin may comprise up to about 50% by weight polymeric fibre, based on the total weight of the thermoset resin, for example, from about 0.1 to about 50% by weight. In certain embodiments, the thermoset resin comprises at least about 10% by weight, or at least about 20% by weight, or at least about 30% by weigh, or at least about 40% by weight polymeric fibre.

Geosynthetic Materials

In certain embodiments, the polymeric fibre is incorporated in a geosynthetic material, In certain embodiments, a geosynthetic material is formed of the polymeric fibre.

Geosynthetic are products used to stabilize terrain and/or solve civil engineering problems. This includes at least the following main product categories: geotextiles, geogrids, geonets, geospacers, geomembranes, geosynthetic clay liners, and geocomposites. The polymeric nature of the products makes them suitable for use in the ground where high levels of durability are required. They can also be used in exposed applications.

The geosynthetic material may be prepared in a wide range of forms. Applications include civil, geotechnical, transportation, geo-environmental, hydraulic, and development applications including roads, airfields, railroads, embankments, retaining structures, reservoirs, canals, dams, erosion control, sediment control, landfill liners, landfill covers, mining, aquaculture and agriculture.

In certain embodiments, the geosynthetic material is a geotextile. They are textiles consisting of synthetic fibers rather than natural ones such as cotton, wool, or silk, making them less susceptible to bio-degradation. A geotextile may be manufactured from the polymeric fibres using standard weaving machinery, or matted together in a random nonwoven manner, or knitted. The geotextile may be porous to liquid flow across its manufactured plane and also within its thickness

In certain embodiments, the geosynthetic material is a geogrid. A geogrid may be manufactured by forming the polymeric fibres into very open, gridlike configuration, i.e., they have large apertures between individual ribs in the transverse and longitudinal directions. In certain embodiments, the geogrid is (a) either stretched in one, two or three directions for improved physical properties, (b) made on weaving or knitting machinery by standard textile manufacturing methods, or (c) by laser or ultrasonically bonding rods or straps together. There are many specific application areas. In certain embodiments, the geogrid functions as a reinforcement material.

In certain embodiments, the geosyntheitc material is a geonets, or the related geospacer. They may be manufactured by a continuous extrusion of parallel sets of polymeric fibres (optionally in the form of ribs) at acute angles to one another. In certain embodiments, when the ribs are opened, relatively large apertures are formed into a netlike configuration. In certain embodiments, the geonet is biplanar or triplanar. Applications include drainage where they are used to convey liquids or gases.

In certain embodiments, the geosynthetic material is a geomembrane. These materials are normally relatively thin, impervious sheets used primarily for linings and covers of liquids- or solid-storage facilities. This includes all types of landfills, surface impoundments, canals, and other containment facilities. A primary function is containment as a liquid or vapor barrier or both. Other application areas include geotechnical, transportation, hydraulic, and development engineering (such as aquaculture, agriculture, heap leach mining, etc.).

In certain embodiments, the geosynthetic material is a geocomposite and comprises or consists of a combination of geotextiles, geogrids, geonets and/or geomembranes, for example, in a factory fabricated unit. In certain embodiments, any one or more of these four materials can be combined with another synthetic material (e.g., deformed plastic sheets or steel cables) or even with soil.

In certain embodiments, the geosynthetic material is geosynthetic clay liners (GLCs, comprising rolls of fabricated thin layers of bentonite clay (or other clay materials) sandwiched between two geotextiles or bonded to a geomembrane. Structural integrity of the subsequent composite may be obtained by needle-punching, stitching or adhesive bonding. The GCLs may be used as a composite component beneath a geomembrane or in geo-environmental and containment applications as well as in transportation, geotechnical, hydraulic, and development applications.

Landscaping Fabric

In certain embodiments, the polymeric fibre is incorporated in a landscaping fabric. In certain embodiments, a landscaping fabric is formed of the polymeric fibre. In certain embodiments, the polymeric fibre is used as a partial or total replacement for polypropylene, which is conventionally used in landscaping fabrics. In certain embodiments, the landscaping fabric is a weed control membrane. The fabric may be treated with a UV protector.

Roofing Underlay

In certain embodiments, the polymeric fibre is incorporated in a roofing underlay. In certain embodiments, a roofing underlay is formed of the polymeric fibre. Roofing underlays are typically positioned over the roofing structure, i.e. rafters and sarking boarding, and below the slating or tiling. In certain embodiments, the roofing underlay is compliant with BS 5534 or any equivalent standard.

In certain embodiments, the roofing underlay is a high water vapour resistance (type HR) underlay that has a water vapour resistance in excess of 50 MNs/g, which effectively prevents the transfer of water vapour. In other embodiments, the roofing underlay is a low water vapour resistance (type LR) underlay that has a water vapour resistance not more than 0.25 MNs/g, which allows the transfer of water vapour. LR underlays are sometimes referred to as vapour permeable or breather underlays.

Automotive Coverings

In certain embodiments, the polymeric fibre is incorporated in an automotive covering. In certain embodiments, an automotive covering is formed of the polymeric fibre. Automotive coverings include automotive carpets, which may be moulded, or cut and sewn. The carpet may be moulded to fit the contours of a specific floor plan of an automotive vehicle. In other embodiments, the automotive covering is in the form of a kick panel, door panel, wheel wall or tail gate piece. The polymeric fibre may be incorporated as the covering which is visible in use, or incorporated as a backing for the automotive covering. In certain embodiments, the automotive covering is a non-fixed, replaceable floor mat.

Backing Material for Floor Coverings

In certain embodiments, the polymeric fibre is incorporated in a backing material for flooring, for example, carpets other than automotive carpets. In certain embodiments, the backing material is formed of the polymeric fibre. In certain embodiments, the carpet is a textile floor covering comprising an upper layer of pile attached directly or indirectly to the backing material. The carpet may be for industrial, commercial or household use. The term ‘carpet’ used herein includes rugs and mats and the like.

The backing material may be a primary or secondary backing material. The pile of a carpet is typically attached or secured to a primary backing material, and then a secondary backing material may be attached or secured (e.g., with a bonding agent or adhesive) to the primary backing material to provide additional pile stability and/or dimensional stability to the carpet structure.

Furniture

In certain embodiments, the polymeric fibre is incorporated in an article of furniture. In certain embodiments, an article of furniture, or one or more parts thereof, is formed of the polymeric fibres.

Items of furniture are many and various and include, but are not limited to, tables, chairs, sofas, couches, stools, desks, drawer units, and the like.

An article of furniture, or one or more parts thereof (e.g., legs, arm rests, drawers, frames, etc.), comprising the polymeric may be manufactured by any suitable method, for example, by extrusion or moulding.

Article Requiring a Dead Fold and/or Twist Retention and/or Memoryless Capability.

It has surprisingly been found that the polymeric fibres have advantageous dead fold and twist retention properties, i.e., they have little or no memory. The term “dead fold” may be taken to be a measure of the polymeric fibre's or article's ability to retain a fold or crease. The term “twist retention” may be taken to be a measure of the polymeric fibre's or articles' ability to retain a twist following twisting. Any suitable method used in the art may be used to assess these properties.

Articles include wrapping and packaging, for example, for food stuffs such as candy or fresh produce, twist closures for bags and the like, plant ties and cable ties.

In certain embodiments, the polymeric fibre is incorporated in strapping, for example, for the banding of goods or strapping them to pallets and the like for transportation. In certain embodiments, strapping is formed of the polymeric fibres. Conventional strapping is difficult to dispose of as it springs back to a straightened state and it is very difficult to put a dead fold in it and is therefore extremely bulky to dispose of. Further, strapping made from polypropylene is known to have poor tensile retention, losing much of its original tension in the first 24 hours, and moreover suffers from UV exposure. Strapping made from the polymeric fibres of the present invention can ameliorate these problems. In certain embodiments, the strapping comprises, or is formed of, polymeric fibres comprising carbon black, which may further enhance resistance to degradation upon exposure to UV radiation.

Such articles may be manufactured by any suitable method by which the article retains a suitable level of dead fold and/or twist retention.

Methods of Manufacture

The polymeric fibre may be made by any suitable method. In certain embodiments, the polymeric fibre is manufactured by a process which comprises extruding a polymer resin having a composition suitable to form the desired polymeric fibre.

The polymer resin may be made by a method comprising compounding the recycled polymer blend and optional additional components. Compounding per se is a technique which is well known to persons skilled in the art of polymer processing and manufacture. It is understood in the art that compounding is distinct from blending or mixing processes conducted at temperatures below that at which the constituents become molten.

Such methods include compounding and extrusion. Compounding may be carried out using a twin screw compounder, for example, a Baker Perkins 25 mm twin screw compounder. The polymers and optional additional components (e.g., one or more of compatabilizer, secondary filler, impact modifier and additional polymer) may be premixed and fed from a single hopper. The resulting melt may be cooled, for example, in a water bath, and then pelletized.

The compounded compositions may further comprise additional components, such as slip aids (for example Erucamide), process aids (for example Polybatch® AMF-705), mould release agents and antioxidants. Suitable mould release agents will be readily apparent to one of ordinary skill in the art, and include fatty acids, and zinc, calcium, magnesium and lithium salts of fatty acids and organic phosphate esters. Specific examples are stearic acid, zinc stearate, calcium stearate, magnesium stearate, lithium stearate, calcium oleate and zinc palmitate. Slip and process aids, and mould release agents may be added in an amount less than about 5 wt. % based on the weight of the masterbatch.

Polymer fibres may then be extruded using conventional techniques known in the art, as will be readily apparent to one of ordinary skill in the art. In certain embodiments, the manufacturing process comprises extrusion, spinning, quench, drawing, tensioning, stretching (e.g., hot stretching), stabilizing, crimping and cutting.

As discussed above, the extruded polymer resin may be subjected to orientating during manufacture of the polymeric fibre. As discussed above, this may improve or enhance a mechanical property, such as tensile strength, and/or thermal stability and melting temperature

In another embodiment, there is provided the use of composition comprising a recycled polymer blend (including the polymer blends described above) in the manufacture of a polymeric fibre for use in a cementitious construction material.

In another embodiment, there is provided the use of composition comprising a recycled polymer blend (including the polymer blends described above) and a compatabilizer (including the compatabilizers described above) for the polymer blend in the manufacture of a polymeric fibre use in a cementitious construction material.

In another embodiment, there is provided the use of a polymeric fibre according to certain embodiments described herein to reinforce a cementitious construction material.

The present application is also directed to the subject-matter described in the following numbered paragraphs:

1. A polymeric fibre for use in a cementitious construction material, wherein the polymeric fibre comprises a recycled polymer blend.

2. A polymeric fibre according to numbered paragraph 1, wherein the polymeric fibre comprises a compatabilizer for the polymer blend.

3. A polymeric fibre according to numbered paragraph 1 or 2, further comprising virgin polymer.

4. A polymer fibre according to numbered paragraph 1 or 2, wherein all of the polymer in the polymeric fibre is recycled polymer.

5. A polymeric fibre according to any preceding numbered paragraph, wherein the recycled polymer blend comprises or is derived from post-consumer polymer waste.

6. A polymeric fibre according to any preceding numbered paragraph, wherein the recycled polymer blend comprises polyethylene, for example, HDPE, and optionally polypropylene.

7. A polymer fibre according to any one of numbered paragraphs 2-6, wherein the compatabilizer comprises an inorganic particulate and surface treatment agent on a surface of the inorganic particulate.

8. A polymeric fibre according to numbered paragraph 7, wherein the inorganic particulate material is calcium carbonate, for example, GCC.

9. A polymeric fibre according to numbered paragraph 7 or 8, wherein the polymers of the recycled and optional virgin polymer are coupled to the inorganic particulate via the surface treatment agent on a surface of the inorganic particulate.

10. A polymeric fibre according to any one of numbered paragraphs 7-9, wherein the surface treatment agent comprises a first compound including a termination propanoic group or ethylenic group with one or two adjacent carbon groups.

11. A polymeric fibre according to any one of numbered paragraphs 7-9, wherein the surface treatment agent is an organic linker obtained by at least partially dehydrating an organic acid having an oxygen-containing acid functionality and comprising at least one carbon-carbon double bond in the presence of the particulate.

12. A polymeric fibre according to any preceding numbered paragraph, further comprising filler in addition to the compatabilizer when present.

13. A polymeric fibre according to numbered paragraph 12, wherein the filler is talc.

14. A polymeric fibre according to numbered paragraph 12 or 13, wherein the filler is present in an amount of at least about 1% by weight, based on the total weight of the polymeric fibre

15. A polymer fibre according to any preceding numbered paragraph, further comprising an impact modifier, for example, a thermoplastic elastomer.

16. A polymeric fibre according to numbered paragraph 15, wherein the impact modifier is an optionally recycled styrene-butadiene-styrene block copolymer.

17. A polymeric fibre according to any preceding numbered paragraph which is formed by extrusion.

18. A polymeric fibre according to numbered paragraph 17, wherein the polymeric fibre is formed by extruding a polymer resin having an MFI of at least about 1.0 g/10 mins (2.16 kg @ 190° C.).

19. A polymeric fibre according to any preceding numbered paragraph, wherein the polymeric fibre has a density such that the fibre sinks in a body of water.

20. A polymeric fibre according to any preceding numbered paragraph, wherein the polymeric fibre has a density of greater than 1.0 g/cm³.

21. A polymeric fibre according to any preceding numbered paragraph having: a substantially circular cross-section, optionally of diameter in the range of from about 0.1 to 10 mm; and/or a length of up to about 1000 mm.

22. A polymeric fibre according to any preceding numbered paragraph, wherein the polymeric fibre comprises at least about 50% by weight polypropylene, based on the total weight of the polymeric fibre, for example, at least about 60% by weight polypropylene, or at least about 70% by weight polypropylene.

23. A polymeric fibre according to any preceding numbered paragraph, wherein the polymeric fibre has one or more of the following properties:

a. a tensile strength of at least 400 MPa; and/or

b. resistant to alkali; and/or

c. hydrophilic; and/or

d. a melting point of at least about 160° C.;

24. A polymeric fibre according to any preceding numbered paragraph, wherein the polymeric fibre is suitable for use in a fibre-reinforced concrete meeting standards BS EN14489 and/or ASTM C 116-03.

25. A polymeric fibre according to any preceding numbered paragraph, wherein the polymeric fibre is highly orientated.

26. A polymeric fibre in accordance with any preceding numbered paragraph, wherein the polymer fibre is in the form of a filament, for example, a monofilament or a multifilament.

27. A cementitious construction material comprising polymeric fibres according to any one of numbered paragraphs 1-26.

28. The cementitious construction material of numbered paragraph 27, wherein the construction material is concrete.

29. The cementitious construction material according to numbered paragraph 28, wherein the cementitious constructions material meets standards BS EN14489 and/or ASTM C 116-03.

30. A structure or structural component formed from the cementitious construction material according to any one of numbered paragraphs 27-29.

31. A method of manufacturing a polymer fibre according to any one of numbered paragraphs 1-26, comprising extruding a polymer resin having a composition suitable to form a polymeric fibre according to any one of numbered paragraphs 1-26.

32. The method of numbered paragraph 31, comprising orientating the polymeric fibre during its manufacture.

33. A method of manufacturing a cementitious construction material according to any one of numbered paragraphs 27-29, comprising incorporating polymeric fibres according to any one of numbered paragraphs 1-26 in the cementitious construction material.

34. Use of composition comprising a recycled polymer blend in the manufacture of a polymeric fibre for use in a cementitious construction material.

35. Use of composition comprising a recycled polymer blend and a compatabilizer for the polymer blend in the manufacture of a polymeric fibre use in a cementitious construction material.

36. Use of a polymeric fibre according to any one of numbered paragraphs 1-26 to reinforce a cementitious construction material.

1. A polymeric fibre comprising a recycled polymer blend and a compatabilizer for the polymer blend, wherein the compatabilizer comprises an inorganic particulate and surface treatment agent on a surface of the inorganic particulate, and wherein the polymeric fibre is suitable for use:
(i) in a cementitious construction material; or
(ii) in a thermoset resin; or
(iii) in or as a geosynthetic material; or
(iv) in or as a landscaping fabric; or
(v) in or as a roofing underlay; or
(vi) in or as an automotive covering or floor carpet; or
(vii) in or as backing material for a floor covering or carpet; or
(viii) in furniture; or
(ix) in or as an article requiring a deadfold, twist retention, or memoryless capability.

2. A polymeric fibre according to claim 1, further comprising virgin polymer.

3. A polymer fibre according to claim 1, wherein all of the polymer in the polymeric fibre is recycled polymer.

4. A polymeric fibre according to claim 1, wherein the recycled polymer blend comprises or is derived from post-consumer polymer waste.

5. A polymeric fibre according to claim 1, wherein the recycled polymer blend comprises polyethylene, HDPE, or polypropylene.

6. A polymeric fibre according to claim 1, wherein the inorganic particulate material is a calcium carbonate.

7. A polymeric fibre according to claim 1, wherein the polymers of the recycled and optional virgin polymer are coupled to the inorganic particulate via the surface treatment agent on a surface of the inorganic particulate.

8. A polymeric fibre according to claim 1, wherein the surface treatment agent comprises a first compound including a terminating propanoic group or ethylenic group with one or two adjacent carbon groups.

9. A polymeric fibre according to claim 1, wherein the surface treatment agent is an organic linker obtained by at least partially dehydrating an organic acid having an oxygen-containing acid functionality and comprising at least one carbon-carbon double bond in the presence of the particulate.

10. A polymeric fibre according to claim 1, further comprising talc or another filler in addition to the compatabilizer.

11. (canceled)

12. (canceled)

13. A polymer fibre according to claim 1, further comprising a thermoplastic elastomer or another impact modifier.

14. A polymeric fibre according to claim 13, wherein the impact modifier is a recycled styrene-butadiene-styrene block copolymer.

15. A polymeric fibre according to claim 1 which is formed by extrusion.

16. A polymeric fibre according to claim 15, wherein the polymeric fibre is formed by extruding a polymer resin having an MFI of at least about 1.0 g/10 mins (2.16 kg @ 190° C.).

17. A polymeric fibre according to claim 1, wherein the polymeric fibre has a density such that the fibre sinks in a body of water.

18. A polymeric fibre according to claim 1, wherein the polymeric fibre has a density of greater than 1.0 g/cm³.

19. A polymeric fibre according to claim 1, having: a substantially circular cross-section, a diameter in the range of from about 0.1 to 10 mm; and a length of up to about 100 mm.

20. A polymeric fibre according to claim 1, wherein the polymeric fibre comprises at least about 50% by weight polypropylene, based on the total weight of the polymeric fibre.

21. A polymeric fibre according to claim 1, wherein the polymeric fibre has one or more of the following properties:
a. a tensile strength of at least 400 MPa; and/or
b. resistant to alkali;
c. hydrophilic; and
d. a melting point of at least about 100° C.

22. A polymeric fibre according to claim 1, wherein the polymeric fibre is suitable for use in a fibre-reinforced concrete meeting standards BS EN14489 and/or ASTM C 116-03.

23-43. (canceled)
